(19) United States
(12) Patent Application Publication
(10) Pub. No.: US 2026/0327459 A1
(43) Pub. Date: Oct. 22, 2026

(54) INTERIOR MATERIAL FOR VEHICLE AND METHOD FOR PREPARING THE SAME

(71) Applicants: HYUNDAI MOTOR COMPANY, Seoul (KR); Kia Corporation, Seoul (KR); SAMSUNG GRATECH Co., Ltd., Hwaseong-si (KR); DAEHAN SOLUTION CO., LTD., Incheon (KR)

(72) Inventors: Tae Yoon KIM, Hwaseong-si (KR); Oh Deok KWON, Hwaseong-si (KR); Sang Wook KIM, Hwaseong-si (KR); Sang Gyu JI, Sejong-si (KR); Choong Ho KWON, Seoul (KR); Ki Hyun YOO, Seoul (KR); Hyeok Mo BANG, Gochang-gun (KR)

(73) Assignees: HYUNDAI MOTOR COMPANY, Seoul (KR); Kia Corporation, Seoul (KR); SAMSUNG GRATECH Co., Ltd., Hwaseong-si (KR); DAEHAN SOLUTION CO., LTD., Incheon (KR)

(21) Appl. No.: 19/385,994

(22) Filed: Nov. 11, 2025

(30) Foreign Application Priority Data
Apr. 22, 2025 (KR) 10-2025-0052566

(51) Int. Cl. C09J 7/35; B32B 3/26; B32B 5/02; B32B 5/18; B32B 7/12; B60R 13/08; C09J 5/06; C09J 7/10; C09J 7/29

(52) U.S. Cl. CPC C09J 7/35; B32B 3/266; B32B 5/026; B32B 5/18; B32B 7/12; B60R 13/0815; C09J 5/06; C09J 7/10; C09J 7/29; B32B 2250/03; B32B 2250/04; B32B 2266/0278; B32B 2307/718; B32B 2307/7375; B32B 2605/003; C09J 2203/354; C09J 2301/204; C09J 2301/208; C09J 2301/304; C09J 2400/246; C09J 2400/266; C09J 2423/00

(57) ABSTRACT

Disclosed is an interior material for a vehicle, which includes a hot-melt sheet, polyurethane foam attached to one surface of the hot-melt sheet, and an interior sheet attached to an opposite surface of the hot-melt sheet. The hot-melt sheet has a structure in which a plurality of hot-melt films are laminated. The hot-melt film has a plurality of perforation patterns formed in a surface of the hot-melt film.

### CROSS-REFERENCE TO RELATED APPLICATION

This application claims the benefit of priority to Korean Patent Application No. 10-2025-0052566, filed in the Korean Intellectual Property Office on Apr. 22, 2025, the contents of which are incorporated herein by reference in its entirety.

### TECHNICAL FIELD

The present disclosure relates to an interior material for a vehicle, which exhibits excellent sound absorption performance with respect to noise made from an electric vehicle motor and air permeability, and a method for preparing the same.

### BACKGROUND

Efforts to improve noise, vibration, and harshness (NVH) performance—one of the five key performance metrics of a vehicle—have been ongoing for many years. Recently, as the architecture of vehicles shifts from internal combustion engines (ICE) to electric powertrains, the importance of NVH performance has grown significantly. Electric vehicles (EVs), which generally produce less noise than conventional ICE vehicles, reveal new acoustic challenges. Specifically, road noise and wind noise, previously masked by engine sounds in ICE vehicles, become more prominent in EVs. Consequently, there is a growing need to develop vehicle components and systems that address noise and vibration through approaches tailored to the unique characteristics of electric vehicles.

Various studies have been conducted to explore NVH-related technologies aimed at reducing noise and vibration. Among interior components, headlining materials cover a large surface area and therefore contribute significantly to interior noise reduction. Notably, these materials inherently possess sound absorption capabilities relevant to NVH performance, eliminating the need for separate sound-absorbing elements. However, research and development efforts focused specifically on optimizing headlining materials for the unique acoustic conditions of electric vehicles have been relatively limited.

In conventional headlining materials, various fabrics are applied to the skin layer depending on interior design options, while a soft polyurethane foam is used as the backing layer to provide cushioning and tactile comfort. These two layers are typically bonded using a flame-lamination process, in which the surface of the polyurethane foam is partially melted by flame and then pressed against the fabric. After cooling, the layers adhere to form a composite structure. However, this process results in a solidified foam layer of uniform thickness between the skin and foam layers, which limits both sound absorption performance and air permeability.

Therefore, there is a need for a new headlining material that offers enhanced sound absorption capabilities and improved air permeability, including headlining material tailored to address the unique noise characteristics of electric vehicles.

### SUMMARY

An aspect of the present disclosure provides an interior material for a vehicle and a method for preparing the same, which are capable of solving the above-described problems.

More specifically, the present disclosure provides a new interior material, especially, a headlining material for a vehicle, which exhibiting excellent sound absorption performance against a frequency domain of noise made in an electric vehicle, while exhibiting excellent air permeability, and a method for preparing the same.

The technical problems to be solved by the present disclosure are not limited to the aforementioned problems, and any other technical problems not mentioned herein will be clearly understood from the following description by those skilled in the art to which the present disclosure pertains.

In more detail, (1) the present disclosure provides an interior material for a vehicle, which includes a hot-melt sheet, a polyurethane foam attached to one surface of the hot-melt sheet, and an interior sheet attached to an opposite surface of the hot-melt sheet. The hot-melt sheet has a structure in which a plurality of hot-melt films are laminated, and the hot-melt film has a plurality of perforation patterns formed in a surface of the hot-melt film.
(2) The present disclosure provides an interior material for a vehicle, in which the hot-melt film includes at least one selected from polyolefin, thermoplastic polyurethane, polyamide, polyester, polyolefin including a unit derived from carboxylic acid monomers or combinations thereof, in (1).
(3) The present disclosure provides an interior material for a vehicle, in which the hot-melt sheet has a structure in which three to five hot-melt films are laminated, in (1) or (2).
(4) The present disclosure provides an interior material for a vehicle, in which a distance between perforation centers of the hot-melt film ranges from 2 mm to 20 mm, in any one of (1) to (3).
(5) The present disclosure provides an interior material for a vehicle, in which a perforation size of the hot-melt film ranges from 0.3 mm to 1.5 mm, in any one of (1) to (4).
(6) The present disclosure provides an interior material for a vehicle, in which a weight per unit area of the hot-melt sheet ranges from 18 g/m² to 100 g/m², in any one of (1) to (5).
(7) The present disclosure provides an interior material for a vehicle, in which the polyurethane foam is soft polyurethane foam, any one of (1) to (6).
(8) The present disclosure provides an interior material for a vehicle, in which a density of the polyurethane foam ranges from 20 kg/m3 to 40 kg/m3 in any one of (1) to (7).
(9) The present disclosure provides an interior material for a vehicle, wherein the interior sheet includes a knitted fabric, in any one of (1) to (9).
(10) The present disclosure provides an interior material for a vehicle, in which the interior sheet includes at least one selected from polyethylene terephthalate, polyamide, polyurethane, natural hemp fiber or combinations thereof, in any one (1) to (9).
(11) The present disclosure provides an interior material for a vehicle, wherein a weight per unit area of the interior sheet ranges from 100 g/m² to 280 g/m², in any one (1) to (10).
(12) The present disclosure provides an interior material for a vehicle, further includes a base adhesive film attached to a surface, to which the hot-melt sheet is not attached, of opposite surfaces of the polyurethane foam, in any one of (1) to (11).
(13) The present disclosure provides an interior material for a vehicle, in which the base adhesive film includes at least one selected from polyolefin, thermoplastic polyurethane, polyamide, polyester, polyolefin including a unit derived from carboxylic acid monomers or combinations thereof, in any one of (1) to (12).
(14) The present disclosure provides an interior material for a vehicle, in which a weight per unit area of the base adhesive film ranges from 20 g/m² to 100 g/m², in any one of (1) to (13).
(15) The present disclosure provides an interior material for a vehicle, in which an air flow resistance measured in compliance with ISO 9053 is at most 60×10³ N·s/m⁴, in any one of (1) to (14) (16) The present disclosure provides an interior material for a vehicle, in which a sound absorption coefficient measured in compliance with ISO 10354-2:2023 is at least 0.23 at 2,000 Hz, and the sound absorption coefficient is at least 0.54 at 5,000 Hz, in any one of (1) to (15).
(17) The present disclosure provides a method for preparing an interior material, which includes manufacturing a hot-melt sheet having a structure in which a plurality of hot-melt films are laminated by extruding a resin composition including at least one selected from polyolefin, thermoplastic polyurethane, polyamide, polyester, polyolefin including a unit derived from carboxylic acid monomers or combinations thereof, forming a plurality of perforation patterns in a surface of the hot-melt sheet, and attaching a polyurethane foam and an interior sheet to opposite surfaces of the hot-melt sheet, respectively.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating an interior material for a vehicle according to the present disclosure; and

FIG. 2 is a schematic view illustrating an interior material for a vehicle, when a base adhesive film is further provided.

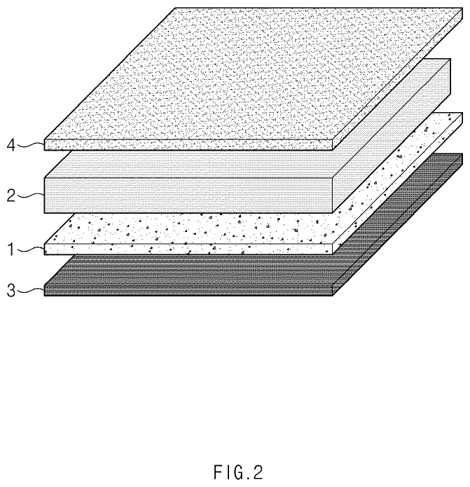

### DETAILED DESCRIPTION

Hereinafter, the present disclosure will be described in more detail.

In this case, terms and words used in the present specification and the claims shall not be limitedly interpreted as commonly-used dictionary meanings, but shall be interpreted as to be relevant to the technical scope of the present disclosure based on the fact that the inventor may properly define the concept of the terms to explain the present disclosure in best ways.

### Interior Material for Vehicle

The present disclosure provides an interior material for a vehicle, which includes a hot-melt sheet, a polyurethane foam attached to one surface of the hot-melt sheet, and an interior sheet attached to an opposite surface of the hot-melt sheet, in which the hot-melt sheet has a structure in which a plurality of hot-melt films are laminated, and the hot-melt film has a plurality of perforation patterns formed in a surface of the hot-melt film.

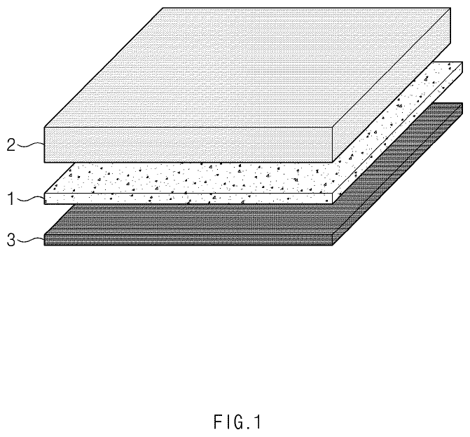

As illustrated in FIG. 1, the interior material for the vehicle according to the present disclosure has a structure in which an interior sheet 3, a hot-melt sheet 1, and a polyurethane foam 2 are laminated in sequence. The interior sheet may be a region exposed to the inside of the vehicle when placed in the vehicle. Noise may be received toward the interior sheet, and may be absorbed while passing through the interior sheet and the hot-melt sheet.

In the interior material for the vehicle according to the present disclosure, the hot-melt sheet may attach the interior sheet to the polyurethane foam, and may absorb noise made inside the vehicle. The hot-melt sheet may have a structure in which a plurality of hot-melt films are laminated. Since the hot-melt sheet has the lamination structure, more improved sound absorption performance may be exhibited. The hot-melt sheet may have a structure in which at least three hot-melt films are laminated, and more preferably, a structure in which three to five hot-melt films are laminated. When the number of hot-melt films is within the above-described range, the hot-melt sheet may be easily fabricated while obtaining sufficient sound absorption performance.

The hot-melt film refers to a film at an individual layer forming the lamination structure of the hot-melt sheet, and may have a plurality of perforation patterns formed in a surface of the film. The air permeability at a specific level or higher may be secured through the perforation patterns, and sound absorption performance for a high-frequency region may be improved.

A distance between perforation centers of the hot-melt film may range from 2 mm to 20 mm. Preferably, the distance may be at least 2 mm, at least 3 mm, at least 4 mm, at least 5 mm, at least 6 mm, or at least 7 mm, and at most 20 mm, at most 19 mm, at most 18 mm, or at most 17 mm. In addition, a perforation size of the hot-melt film may range from 0.3 mm to 1.5 mm. Preferably, the perforation size may be at least 0.4 mm, at least 0.5 mm, or at least 0.6 mm, and at most 1.5 mm, at most 1.4 mm, at most 1.3 mm, at most 1.2 mm, at most 1.1 mm, or at most 1.0 mm. The distance between perforation centers refers to a spacing between the perforations. When the spacing between the perforations and the size of the perforation satisfy the above-described conditions, both of the excellent sound absorption performance and the excellent air permeability may be exhibited.

The hot-melt film includes at least one selected from polyolefin, thermoplastic polyurethane, polyamide, polyester, polyolefin including a unit derived from carboxylic acid monomers or combinations thereof, and preferably includes at least one of the polyolefin or the polyurethane. The types of resins may be easily processed through an extrusion process, may be smoothly attached to the interior sheet and the polyurethane foam, and provides the excellent sound absorption performance and the excellent air permeability.

The weight per unit area of the hot-melt sheet may range from 18 g/m² to 100 g/m², and preferably may be at least 20 g/m² or at least 30 g/m² and at most 60 g/m² or at most 50 g/m². When the weight per unit area is within the above-described range, the durability of the interior material for the vehicle may be ensured to be at a specific level or higher.

The polyurethane foam provides a cushioning sensation to the interior material for the vehicle, and may support the hot-melt sheet and the interior sheet. The polyurethane foam may be soft polyurethane foam to provide improved cushioning sensation.

The density of the polyurethane foam may range from 20 kg/m³ to 40 kg/m³, and preferably may be at least 22 kg/m³, at least 24 kg/m³, or at least 26 kg/m³ and at most 36 kg/m³ or at most 34 kg/m³. The density of the polyurethane foam, which is within the above-described range, may be preferable in terms of the weight reduction of the vehicle and the durability of the interior material.

The interior sheet may be exposed to the interior of the vehicle serve to provide an aesthetic appearance. The interior sheet includes various materials depending on the specifications of the vehicle in which the interior material according to the present disclosure is placed. More specifically, the interior sheet may be a knitted fabric.

In addition, the interior sheet includes at least one selected from polyethylene terephthalate, polyamide, polyurethane, natural hemp fiber or combinations thereof. The types of materials provides an excellent aesthetic appearance and an excellent tactile sensation.

The weight per unit area of the interior sheet may range from 100 g/m² to 280 g/m², and preferably may be at least 120 g/m², at least 130 g/m², or at least 150 g/m² and at most 250 g/m², at most 230 g/m², or at most 200 g/m². When the weight per unit area of the interior sheet satisfies the above-described conditions, the durability of the interior material for the vehicle may be improved.

The interior material for the vehicle according to the present disclosure may further include a base adhesive film attached to a surface, onto which the hot-melt sheet is not attached, of opposite surfaces of the polyurethane foam. The base adhesive film may attach the interior material for the vehicle to a frame of the vehicle.

The base adhesive film includes at least one selected from polyolefin, thermoplastic polyurethane, polyamide, polyester, polyolefin including a unit derived from carboxylic acid monomers or combinations thereof, and preferably includes at least one selected from polyolefin, thermoplastic polyurethane, and polyolefin including a unit derived from carboxylic acid monomers. The material exhibits excellent adhesive force to allow the interior material for the vehicle to be stably attached for a long period.

The weight per unit area of the base adhesive film may range from 20 g/m² to 100 g/m², and preferably may range from 25 g/m² to 55 g/m². Within the above-described range, durability, weight reduction of the vehicle, and the adhesive force of the interior material for the vehicle may be preferably balanced.

The interior material for the vehicle according to the present disclosure may show an air flow resistance of at most 60×10³ N·s/m⁴ measured in compliance with ISO 9053. Preferably, the air flow resistance may be at least 10×10³ N·s/m⁴, at least 20×10³ N·s/m⁴, at least 30×10³ N·s/m⁴, at least 40×10³ N·s/m⁴, or at least 45×10³ N·s/m⁴ and at most 60×10³ N·s/m⁴ or at most 58×10³ N·s/m⁴. The interior material for the vehicle according to the present disclosure may have improved air permeability by satisfying the above conditions.

The interior material for the vehicle according to the present disclosure may have the sound absorption coefficient of at least 0.23 at 2,000 Hz and the sound absorption coefficient of at least 0.54 at 5,000 Hz, as measured in compliance with ISO 10354-2:2023. More specifically, the interior material for the vehicle according to the present disclosure may have the sound absorption coefficient of at least 0.23, at least 0.24, or at least 0.25 and at most 0.35, at most 0.33, at most 0.32, at most 0.31, or at most 0.30 at 2,000 Hz. In addition, the sound absorption coefficient may be at least 0.54, at least 0.55, or at least 0.56 and at most 0.95, at most 0.93, at most 0.90, at most 0.88, or at most 0.87 at 5,000 Hz. The interior material for the vehicle according to the present disclosure may exhibit the excellent sound absorption performance for high-frequency noise, especially, motor noise of an electric vehicle, by satisfying the above conditions.

### Method for Preparing Interior Material for Vehicle

The present disclosure provides a method for preparing the interior material for the vehicle described above.

More specifically, the present disclosure provides the method for preparing the interior material for the vehicle which includes the steps for fabricating the hot-melt sheet having the structure in which the plurality of hot-melt films are laminated by extruding a resin composition including at least one selected from polyolefin, thermoplastic polyurethane, polyamide, polyester, polyolefin including a unit derived from carboxylic acid monomers or combinations thereof, forming the plurality of perforation patterns in the surface of the hot-melt sheet, and attaching the polyurethane foam and the interior sheet to the opposite surfaces of the hot-melt sheet, respectively.

The hot-melt sheet of the interior material for the vehicle described above may be fabricated through the extrusion process. The extrusion process may be performed by simultaneously extruding the hot-melt films to be included in the hot-melt sheet while laminating the hot-melt films, or by individually extruding and fabricating each hot-melt film, and laminating the hot-melt films, thereby fabricating the hot-melt sheet.

The hot-melt sheet having excellent sound absorption performance and the excellent air permeability may be fabricated by forming a perforation pattern on the hot-melt sheet fabricated through the preceding step. The perforation pattern may be formed under the conditions described above and various known manners may be performed to form the perforation pattern.

After fabricating the hot-melt sheet through the above process, the interior material for the vehicle may be fabricated by attaching the polyurethane foam and the interior sheet to the hot-melt sheet. In this step, the attaching may be performed by attaching one of the polyurethane foam and the interior sheet to the hot-melt sheet, and then by attaching a remaining one of the polyurethane foam and the interior sheet to the opposite surface of the hot-melt sheet, or may be performed by positioning the polyurethane foam and the interior sheet on the opposite surfaces of the hot-melt sheet and simultaneously attaching the three layers.

According to the method for preparing the interior material for the vehicle of the present disclosure, the attachment between the sheets may be performed through a thermal lamination manner or a flame lamination manner. The thermal lamination manner refers to a manner for applying heat the hot-melt sheet, melting a portion of the hot-melt sheet, and then attaching the two layers to each other. The flame lamination manner refers to a manner for burning the foam using a flame to attach the two layers to each other. More specifically, the hot-melt sheet and the interior sheet may be attached to each other through the thermal lamination manner, and the hot-melt sheet and the polyurethane foam may be attached to each other through the flame lamination manner or the thermal lamination manner.

Hereinafter, an embodiment of the present disclosure will be described in more detail. However, the following embodiment is not provided only for the illustrative purpose, and the scope of the present disclosure is not limited thereto.

### Material

The interior sheet was formed by using a knitted fabric having a unit weight of 170 g/m², and forming a skin layer formed as 100% of polyethylene terephthalate-based filament fibers are bounded to each other. The polyurethane foam employed soft polyurethane foam having a density of 26 kg/m3.

### Embodiment 1

A hot-melt sheet having the structure, in which hot melt films were laminated at three layers, was fabricated by simultaneously extruding the polyolefin resin. A plurality of perforation patterns were formed with respect to the hot-melt sheet such that the distance between the centers of the perforations ranges from 11 to 17 mm, and the size of each perforation ranges from 0.6 to 1.0 mm. The knitted fabric is attached to one surface of the hot-melt sheet fabricated through the above process through thermal lamination, and soft polyurethane foam was attached to an opposite surface through thermal or flame lamination to prepare the interior material for the vehicle.

### Embodiment 2

The hot-melt sheet having the structure in which hot-melt films were laminated at a three layer, was fabricated by compressing a thermoplastic polyurethane resin. A plurality of perforation patterns were formed with respect to the hot-melt sheet such that the distance between the centers of the perforations ranges from 8 to 10 mm, and the size of each perforation ranges from 0.4 to 0.8 mm. The knitted fabric and the soft polyurethane foam were attached to the one surface of the hot-melt sheet fabricated through the above process, through the same process as that of Embodiment 1, thereby preparing the interior material for the vehicle.

### Comparative Example 1

The one surface of the soft polyurethane foam including the above material was heated and softened. Thereafter, the knitted fabric of the material was attached to the softened surface. Thereafter, the result is cooled down at the room temperature to solidify the molten soft polyurethane foam, such that a skin composite layer is formed between the soft polyurethane foam and the knitted fabric, thereby producing the interior material for the vehicle.

### Embodiment 2

The hot-melt sheet including one-layer hot melt film was fabricated by extruding polyolefin resin. A plurality of perforation patterns were formed with respect to the hot-melt sheet such that the distance between the centers of the perforations ranges from 3 to 4 mm, and the size of each perforation ranges from 0.4 to 0.8 mm.

The knitted fabric and the soft polyurethane foam were attached to the one surface of the hot-melt sheet fabricated through the above process, through the same process as that of Embodiment 1, thereby preparing the interior material for the vehicle.

### Comparative Example 3

The hot-melt sheet including one-layer hot melt film was fabricated by extruding a polyamide resin. A plurality of perforation patterns were formed with respect to the hot-melt sheet such that the distance between the centers of the perforations ranges from 8 to 10 mm, and the size of each perforation ranges from 0.6 to 1.0 mm.

The knitted fabric and the soft polyurethane foam were attached to the one surface of the hot-melt sheet, which was fabricated through the above process, through the same process as that of Embodiment 1, thereby preparing the interior material for the vehicle.

The hot-melt sheets among the interior materials for the vehicle, which are fabricated according to Embodiments and the Comparative examples, were summarized as shown in Table 1.

TABLE 1

| | | | | Distance | |
|---|---|---|---|---|---|
| | | Weight per | | between | Perforation |
| | | unit area | Layer | perforations | size |
| | Material | (g/m²) | structure | (mm) | (mm) |
| Embodiment 1 | Polyolefin | 35 | Three | 11~17 | 0.6-1.0 |
| | | | layers | | |
| Embodiment 2 | Thermoplastic | 35 | Three | 8~10 | 0.4-0.8 |
| | Polyurethane | | layers | | |
| Comparative | Application of composite skin layer formed by melting soft polyurethane foam | | | | |
| example 1 | | | | | |
| Comparative | Polyolefin | 30 | One layer | 3~4 | 0.4-0.8 |
| example 2 | | | | | |
| Comparative | polyamide | 40 | One layer | 8~10 | 0.6-1.0 |
| example 3 | | | | | |

### Embodiment 1: Measuring Sound Absorption Performance and Air Flow Resistance of Interior Material for Vehicle

The sound absorption performance at each frequency and the air flow resistance of the sound-absorbing material for the vehicle, which is prepared according to the embodiments and the comparative examples, were measured. The specific measurement manners are as follows.

### 1) Sound Absorption Performance at Each Frequency

The sound absorption performance at each frequency was measured in compliance with ISO 10354-2:2023 using a Two-microphone Impedance Measurement Tube. The sound absorption performance was measured in terms the interior sheet including the interior material for the vehicle.

### 2) Air Flow Resistance

The air flow resistance was measured in compliance with ISO 9053.

The measurement result was summarized as shown in following Table 2.

TABLE 2

| | | | | | | | | Air flow |
|---|---|---|---|---|---|---|---|---|
| | Sound absorption performance at each frequency | | | | | | | resistance |
| | 1,000 Hz | 1,250 Hz | 1,600 Hz | 2,000 Hz | 3,150 Hz | 5,000 Hz | 6,300 Hz | (N · s/m⁴) |
| Embodiment 1 | 0.152 | 0.210 | 0.295 | 0.399 | 0.640 | 0.867 | 0.874 | 46*10³ |
| Embodiment 2 | 0.134 | 0.162 | 0.200 | 0.272 | 0.452 | 0.561 | 0.610 | 58*10³ |
| Comparative | 0.112 | 0.132 | 0.159 | 0.213 | 0.376 | 0.503 | 0.527 | 94*10³ |
| example 1 | | | | | | | | |
| Comparative | 0.118 | 0.148 | 0.198 | 0.248 | 0.414 | 0.525 | 0.578 | 72*10³ |
| example 2 | | | | | | | | |
| Comparative | 0.181 | 0.237 | 0.250 | 0.226 | 0.210 | 0.167 | 0.156 | 65*10³ |
| example 3 | | | | | | | | |

It may be recognized through the result of Table 2 that the interior material for the vehicle according to an embodiment of the present disclosure exhibits the low air flow resistance and the excellent sound absorption performance.

In particular, the interior material for the vehicle according to Embodiments 1 and 2 exhibited excellent sound absorption performance in the noise frequency range of 2,000 Hz to 5,000 Hz, which corresponds to the range of the noise made by electric vehicle motors. In addition, it may be recognized that the low air flow resistance made the excellent air permeability.

In contrast, the interior material for the vehicle according to Comparative example 1, which the composite layer is formed by softening the soft polyurethane foam using a flame as in the conventional manner, was inferior in sound absorption performance and air flow resistance, when compared to Embodiments. In addition, Comparative examples 2 and 3, in which the hot-melt sheet is in a single layer structure, instead of a multiple layer structure, were inferior when compared to the Embodiments.

Accordingly, it may be recognized that the interior material for the vehicle according to the present disclosure is suitable for the electric vehicle which makes noise in the high frequency region.

According to the present disclosure, the interior material for the vehicle may exhibit the excellent sound absorption performance against noise made from the electric vehicle motor, excellent air permeability, and may be suitable as the interior material for the vehicle of the electric vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An interior material for a vehicle, the interior material comprising:
a hot-melt sheet;
a polyurethane foam attached to one surface of the hot-melt sheet; and
an interior sheet attached to an opposite surface of the hot-melt sheet,
wherein the hot-melt sheet has a structure in which a plurality of hot-melt films are laminated, and
wherein the hot-melt film has a plurality of perforation patterns formed in a surface of the hot-melt film.

2. The interior material of claim 1, wherein the hot-melt film includes:
at least one selected from polyolefin, thermoplastic polyurethane, polyamide, polyester polyolefin including a unit derived from carboxylic acid monomers or combinations thereof.

3. The interior material of claim 1, wherein the hot-melt sheet has a structure in which three to five hot-melt films are laminated.

4. The interior material of claim 1, wherein a distance between perforation centers of the hot-melt film ranges from 2 mm to 20 mm.

5. The interior material of claim 1, wherein a perforation size of the hot-melt film ranges from 0.3 mm to 1.5 mm.

6. The interior material of claim 1, wherein a weight per unit area of the hot-melt sheet ranges from 18 g/m² to 100 g/m².

7. The interior material of claim 1, wherein the polyurethane foam is soft polyurethane foam.

8. The interior material of claim 1, wherein a density of the polyurethane foam ranges from 20 kg/m³ to 40 kg/m³.

9. The interior material of claim 1, wherein the interior sheet includes a knitted fabric.

10. The interior material of claim 1, wherein the interior sheet includes:
at least one selected from polyethylene terephthalate, polyamide, polyurethane, natural hemp fiber or combinations thereof.

11. The interior material of claim 1, wherein a weight per unit area of the interior sheet ranges from 100 g/m² to 280 g/m².

12. The interior material of claim 1, further comprising:
a base adhesive film attached to a surface, to which the hot-melt sheet is not attached, of opposite surfaces of the polyurethane foam.

13. The interior material of claim 12, wherein the base adhesive film includes:
at least one selected from polyolefin, thermoplastic polyurethane, polyamide, polyester, polyolefin including a unit derived from carboxylic acid monomers or combinations thereof.

14. The interior material of claim 12, wherein a weight per unit area of the base adhesive film ranges from 20 g/m² to 100 g/m².

15. The interior material of claim 1, wherein an air flow resistance measured in compliance with ISO 9053 is at most 60×10³ N·s/m⁴.

16. The interior material of claim 1, wherein a sound absorption coefficient measured in compliance with ISO 10354-2:2023 is at least 0.23 at 2,000 Hz, and wherein the sound absorption coefficient is at least 0.54 at 5,000 Hz.

17. A method for preparing an interior material, the method comprising:
manufacturing a hot-melt sheet having a structure in which a plurality of hot-melt films are laminated by extruding a resin composition including at least one selected from polyolefin, thermoplastic polyurethane, polyamide, polyester, polyolefin including a unit derived from carboxylic acid monomers or combinations thereof,
forming a plurality of perforation patterns in a surface of the hot-melt sheet; and
attaching a polyurethane foam and an interior sheet to opposite surfaces of the hot-melt sheet, respectively.
